(19) United States
(12) Patent Application Publication
(10) Pub. No.: US 2024/0178387 A1
(43) Pub. Date: May 30, 2024

(54) COMPONENT FOR USE IN AN ENERGY STORAGE DEVICE OR AN ENERGY CONVERSION DEVICE AND METHOD FOR THE MANUFACTURE THEREOF

(71) Applicant: ILIKA TECHNOLOGIES LTD, Romsey Hampshire (GB)

(72) Inventors: Robert Noble, Lockerley, Hampshire (GB); Kyriakos Giagloglou, Romsey (GB); Donato Ercole Conte, Southampton (GB)

(73) Assignee: ILIKA TECHNOLOGIES LTD, Romsey Hampshire (GB)

(21) Appl. No.: 18/553,235

(22) PCT Filed: Apr. 29, 2022
(86) PCT No.: PCT/GB2022/051115

§ 371 Date: Sep. 29, 2023

(30) Foreign Application Priority Data
Apr. 29, 2021 (GB) 2106150.2

(51) Int. Cl. H01M 4/525; H01M 4/02; H01M 4/04; H01M 4/505; H01M 4/62; H01M 4/74

(52) U.S. Cl. CPC H01M 4/525; H01M 4/0414; H01M 4/0416; H01M 4/0471; H01M 4/505; H01M 4/626; H01M 4/747; H01M 2004/021

(57) ABSTRACT

A component for use in an energy storage device or an energy conversion device comprises a first part and a second part, wherein the first part comprises particles of a ceramic material, and the second part is provided by a sheet having a plurality of through-thickness apertures. The second part is at least partially embedded in the first part.

### FIELD OF THE INVENTION

The present invention relates to a component for use in an energy storage device or an energy conversion device, in particular to a component for use in batteries, capacitors, fuel cells (including solid oxide fuel cells and polymer electrolyte fuel cells), photovoltaic devices, piezoelectric devices, or thermoelectric converters, and to a method for the manufacture thereof.

### BACKGROUND TO THE INVENTION

Energy storage or energy conversion devices, such as batteries, capacitors, fuel cells (including solid oxide fuel cells and polymer electrolyte fuel cells), photovoltaic devices, piezoelectric devices, or thermoelectric converters typically comprise components that are manufactured through the sintering of ceramic particles. However, in many cases, high temperatures (e.g. in excess of 1000° C.) are required to produce an adequately sintered component. The application of such temperatures often has undesirable side-effects, such as chemical decomposition, reaction between different materials to form deleterious secondary phases, and/or evaporation of volatile species. Additionally, the use of these high temperatures may be incompatible with the presence of other components of the device during the sintering process.

A known method for sintering ceramic components at lower temperatures is cold sintering, as described, for example, in WO 2017/058727, which is hereby incorporated by reference. Cold sintering may be defined as a process for preparing a sintered material by wetting at least one inorganic compound in particle form with a solvent that can partially solubilise the inorganic compound; and subsequently applying pressure and heat to the wetted particles of the inorganic compound to evaporate the solvent and densify the inorganic compound to form the sintered material. Typically, the wetted particles are heated to a temperature of no more than 200° C. above the boiling point of the solvent at atmospheric pressure. In certain cases, the wetted particles are heated to an absolute temperature of no more than 250° C.

It is desirable to develop manufacturing procedures for components of energy storage or energy conversion devices that enable the use of cold sintering.

In particular, it is desirable to develop such manufacturing procedures for components of battery cells, such as solid-state lithium-ion battery cells.

A solid-state lithium-ion battery cell is a type of rechargeable battery cell in which lithium ions (Li⁺) move from the negative electrode (anode) to the positive electrode (cathode) during discharge and back when charging. The electrodes are each capable of reversibly storing lithium ions and are separated by a solid bulk electrolyte, which allows for ionic transport.

Additional components such as current collectors, interface modifiers and/or encapsulations or other protective elements may also be provided. In certain cases, the negative electrode is not present in the battery cell immediately after assembly of the cell, but is instead provided as a lithium anode formed during initial charging of the battery cell.

Solid-state battery cells may provide multiple advantages over liquid electrolyte lithium-ion battery cells, such as increased energy density, increased power density, low leakage currents and/or reduced flammability. Thus, solid-state battery cells have been considered for use in, for example, electric vehicles and consumer electronics.

In the case of large format solid state battery cells (e.g. for use in electric vehicles), components such as the electrodes are typically manufactured through sintering of particles of the constituent materials. It is desirable to reduce sintering temperatures for the reasons set out above in relation to energy storage and energy conversion devices in general, and additionally or alternatively to help reduce the evaporative loss of Li during sintering.

### SUMMARY OF THE INVENTION

Previous cold sintering processes have involved applying pressure and heat to a mixture of particles of an inorganic compound and a solvent, while the mixture is held in a die. However, when manufacturing components of energy storage or energy conversion devices, it is undesirable to use a die in this way, as it is thought to limit the size of device that can be provided and/or to make close control of the thickness of the layers of the device more difficult. Instead, it is preferred to apply uniaxial pressure to the particle-solvent mixture without the presence of lateral constraints such as die walls.

However, as a result of this, the mixture tends to expand in a lateral direction when placed under pressure during the sintering process, and this tends to be followed by relaxation of the sintered component when the pressure is removed. Consequently, the sintered component may become detached from the underlying substrate when the pressure is removed. This may prevent the use of a one-step procedure, for example, where an electrode for a battery cell is sintered directly on top of the current collector of the battery cell.

Surprisingly, it has been found that these problems may be lessened by locating the particle-solvent mixture on a mesh, or more generally, on a substrate having a plurality of through-thickness apertures. It is thought that this arrangement may allow the particles to penetrate into the apertures of the substrate when the particle-solvent mixture is placed under pressure and sintered, such that the resulting sintered component remains attached to the substrate after the pressure is removed. It is thought that the step of embedding the substrate partially or wholly in the sintered component may also help to strengthen the component.

Therefore, in a first aspect, the present invention may provide a component for use in an energy storage device or an energy conversion device, the component comprising a first part and a second part, wherein the first part comprises particles of a ceramic material, and the second part is provided by a sheet having a plurality of through-thickness apertures;
wherein the second part is at least partially embedded in the first part.

The second part may be partially or wholly embedded in the first part.

For example, the second part may be embedded to a depth in the range 5-200 μm. In this case, the range of 5-200 μm represents the thickness of the portion of the first part that lies between the second part and the adjacent face of the first part. In certain cases, the second part may be embedded to a depth in the range 5-100 μm. In certain cases, the second part may be embedded to a depth in the range 5-50 μm.

Typically, the component comprises a sintered, ceramic-containing body in which the sheet having a plurality of through-thickness apertures is partially or wholly embedded.

The term ceramic refers to an inorganic, non-metallic material. The ceramic material may be selected from the group consisting of: electrode active materials; electrolytes; piezoelectric materials; photovoltaic materials; and thermoelectric materials. For the avoidance of doubt, other materials, for example, particles of a further ceramic material, may also be present in the first part of the component.

Typically, the component is an electrode.

In certain cases, the component may be an electrode for a battery cell, such as a solid state battery cell. In such cases, the electrode may have a thickness in the range 70-1000 μm. In certain cases, the component may be an electrode for a battery cell that comprises a liquid electrolyte. In such cases, the electrodes of the battery cell may be held apart by a separator, such as a porous polymer membrane, while the liquid electrolyte provides an ion-conducting medium that allows for ionic transport between, and in certain cases, within the electrodes. In the case that the first part of the component is a sintered, ceramic-containing body, this typically provides enough porosity to allow penetration of the liquid electrolyte into the component when used as an electrode, thus enhancing ionic transport within the battery and reducing internal resistance.

In certain cases, the component may be an electrode for a battery cell and the ceramic material may be an electrode active material. The electrode active material may be a positive electrode active material or a negative electrode active material.

A positive electrode active material may be a lithium-containing material, a sodium-containing material, or a magnesium-containing material. In general, the positive electrode active material is a lithium-containing material.

Particles of a positive electrode active material may comprise at least one positive electrode active material selected from the group consisting of: lithium nickel cobalt aluminium oxide (LiNiₓCo_{y}Al_{z}O₂, wherein x>0; y>0; z>0 and x+y+z=1); lithium cobalt oxide (LiCoO₂); lithium iron phosphate (LiFePO₄); lithium manganese nickel oxide (LiMn_{1.5}Ni_{0.5}O₄); lithium cobalt phosphate (LiCoPO₄); lithium nickel cobalt manganese oxide (LiNiₓCo_{y}Mn_{z}O₂, wherein x>0; y>0; z>0 and x+y+z=1); vanadium oxide (V₂O₅); LiVOPO₄; Li₃V₂(PO₄)₃, and LiMPO₄ (wherein M=Ni or Mn).

Particles of a negative electrode active material may comprise at least one negative electrode active material selected from the group consisting of lithium titanate oxide (Li₄Ti₅O₁₂ or Li₂TiO₃) and tin oxide.

In certain cases, the particles of the electrode active material may comprise a first electrode active material that is coated by a second electrode active material.

In certain cases, the second part of the component is provided by a sheet of electronically conductive material.

For example, the second part may comprise a metal or a metal alloy. The metal or metal alloy may be selected from the group consisting of iron, steel (including stainless steel, that is, steel containing at least 10 wt % chromium), nickel, nickel-based alloys containing at least 50 wt % nickel, copper, copper-based alloys containing at least 50 wt % copper, aluminium, aluminium-based alloys containing at least 50 wt % aluminium, platinum, and platinum-based alloys containing at least 50 wt % platinum. Thus, the second part may comprise a metal or a metal alloy comprising one or more atomic elements selected from the group consisting of: iron, nickel, copper, aluminium, titanium, and platinum.

In the case that the component is an electrode for a battery cell, the use of a sheet of electronically conductive material for the second part of the component may allow the second part to function as a current collector of the battery cell. By providing a current collector having through-thickness apertures, the weight of the current collector may be reduced. Thus, the energy density of the battery cell may be increased. Furthermore, since the sheet is partially or wholly embedded in the first part of the component, the interfacial contact area between the electrode active material and the sheet may be increased relative to a configuration in which a current collector is provided as a discrete layer having a planar interface with an electrode. Thus, the internal resistance of the battery cell may be reduced. In other cases, the second part of the component may comprise a polymeric material. The presence of such a sheet may assist in strengthening the component.

In certain cases, the second part of the component has a weight per unit area in the range 0.005-0.1 g/cm². In certain cases, the second part has a weight per unit area in the range 0.01-0.05 g/cm². Typically, the second part has a weight per unit area below 0.1 g/cm², preferably below 0.05 g/cm², more preferably below 0.04 g/cm².

Preferably, the second part has a maximum thickness in the range 50-300 μm. In the case that the second part is a woven mesh, the maximum thickness may be at the point where two strands of the mesh cross.

Typically, the through-thickness apertures of the second part are arranged in a regular array. For example, the through-thickness apertures may be arranged in a grid.

For the avoidance of doubt, the term “through-thickness aperture” may be defined as an aperture that extends in a transverse direction of the sheet, directly from a first face of the sheet to a second, opposing face of the sheet.

In certain cases, the sheet having the plurality of through-thickness apertures may be provided by a sheet having a plurality of through-thickness perforations, such as a grating.

In general, however, the second part is provided by a woven mesh. Woven meshes, generally comprising strands of a metal or metal alloy, are commercially available in different varieties, having different numbers of strands per unit distance measured in a direction perpendicular to the strands. When a mesh has a low number of strands per unit distance, the individual strands tend to have a high thickness and thus the mesh weight per unit area tends to be high. Therefore, it is generally preferable to avoid meshes having a very low number of strands per unit distance. Conversely, when a mesh has a high number of strands per unit distance, the gaps between the strands may be small and it may be difficult to provide a component in which the second part is securely embedded in the first part.

Typically, the woven mesh has 5-500 strands per cm, when measured in a direction perpendicular to the strands. In certain cases, the woven mesh has 30-250 strands per cm, when measured in a direction perpendicular to the strands. In other cases, the woven mesh has 30-100 strands per cm, when measured in a direction perpendicular to the strands.

In general, it is desirable that the through-thickness apertures of the second part have a size that enables them to be penetrated by the particles of the ceramic material during manufacture of the electrode.

Typically, the particles of the ceramic material have a d50 size in the range 10 nm to 50 μm, measured using laser diffraction of a liquid dispersion of the particles, following ISO 13320:2020. For example, the particles of the ceramic material may have a d50 size in the range 100 nm to 40 μm. In certain cases, the particles of the ceramic material may have a d50 size in the range 1-40 μm. In certain cases, the particles of the ceramic material may have a d50 size in the range 2-20 μm.

Thus, the through-thickness apertures of the second part typically have a width in the range 10-1000 μm. For example, the apertures may have a width in the range 10-200 μm.

Smaller apertures may allow a thinner and hence lighter sheet to be provided as the second part. Thus, in certain cases, the apertures have a width in the range 50-200 μm.

The width of the aperture is the lesser dimension of the aperture in the plane of the sheet that provides second part. Typically, the apertures have a square shape. In such cases, the width of the aperture corresponds to the length of one side of the square. In certain cases, the apertures may be circular. In such cases, the width of the aperture corresponds to the diameter of the circle. In certain cases, the apertures may have a rectangular shape. In such cases, the width of the aperture corresponds to the length of the shorter sides of the rectangle.

Typically, in the case that the component is an electrode for a battery cell and the ceramic material is an electrode active material, the first part further comprises an ionically-conductive constituent that is distributed between the particles of electrode active material. The ionically-conductive constituent may be a lithium-containing material, a sodium-containing material, or a magnesium-containing material. In general, the ionically-conductive constituent is a lithium-containing material.

The ionically-conductive constituent may comprise one or more compounds selected from the group consisting of: LAGP (Li_{1.5}Al_{0.5}Ge_{1.5}(PO₄)₃); LATP (Li_{1.3}Al_{0.3}Ti_{1.7}(PO₄)₃); NASICON (Na₁₊ₓZr₂SixP₃₋ₓO₁₂, wherein 0<x<3); LISICON (Li₂₊₂ₓZn₁₋ₓGeO₄, wherein 0<x<1); Ohara Lithium Ion Conducting Glass Ceramic (LICGC™); and lithium-stuffed garnets, including compounds having the formula Li_{A}La_{B}M_{C}Zr_{D}O_{E}, wherein 4<A<8.5, 1.5<B<4, 0≤C≤2, 0≤D≤2, 10<E<13 and M=Al, Mo, W, Nb, Sb, Ca, Ba, Sr, Ce, Hf, Rb, or Ta.

The ionically-conductive constituent may additionally include at least one electrolytic salt, for example, one or more salts selected from the group consisting of: LiTFSI (lithium bis(trifluoromethanesulfonyl)imide); LiFSI (lithium bis(fluorosulfonyl)imide) and lithium perchlorate.

Typically, the ionically-conductive constituent has an ionic conductivity of at least 10⁻⁸ Scm⁻¹, measured through impedance spectroscopy at 25° C. In certain embodiments, the ionic conductivity of the ionically conductive constituent may be at least 10⁻⁶ Scm⁻¹. In certain embodiments, the ionic conductivity of the ionically conductive constituent may be at least 10−5 Scm⁻¹. In certain embodiments, the ionic conductivity of the ionically conductive constituent may be at least 10⁻⁴ Scm⁻¹.

The ionically-conductive constituent is typically present in the first part in an amount of 10-50 vol % relative to the total volume of the particles of electrode active material. In certain cases, the ionically-conductive constituent is present in the first part in an amount of 20-40 vol % relative to the total volume of the particles of electrode active material.

In the case that the second part is provided by a sheet of electronically-conductive material, and the component is an electrode for a battery cell, in which the ceramic material is an electrode active material, it is thought that the presence of such a sheet in the electrode may reduce or even eliminate the requirement for an additional electronically-conductive constituent distributed between the particles of electrode active material of the first part. Thus, the energy density of the electrode may be increased. For example, the amount of any additional electronically-conductive constituent distributed between the particles of electrode active material may be less than 10 vol % relative to the total volume of the particles of electrode active material. Preferably, the amount of any additional electronically-conductive constituent distributed between the particles of electrode active material may be less than 5 vol % relative to the total volume of the particles of electrode active material. More preferably, the amount of any additional electronically-conductive constituent distributed between the particles of electrode active material may be less than 2 vol % relative to the total volume of the particles of electrode active material. Even more preferably, the amount of any additional electronically-conductive constituent distributed between the particles of electrode active material may be less than 1 vol % relative to the total volume of the particles of electrode active material.

When present, the additional electronically-conductive constituent typically has an electronic conductivity of at least 10⁻⁴ Scm⁻¹, determined through DC decay measurement at 25° C. In certain embodiments, the electronic conductivity of the additional electronically-conductive constituent may be at least 10⁻³ Scm⁻¹. In certain embodiments, the electronic conductivity of the additional electronically-conductive constituent may be at least 10⁻² Scm⁻¹. In certain embodiments, the electronic conductivity of the additional electronically-conductive constituent may be at least 10⁻¹ Scm⁻¹. In certain embodiments, the electronic conductivity of the additional electronically-conductive constituent may be at least 1 Scm⁻¹. In certain embodiments, the electronic conductivity of the additional electronically-conductive constituent may be at least 10 Scm⁻¹.

When present, the electronically-conductive constituent is typically provided by a carbon material, which may be selected from the group consisting of: carbon black, acetylene black, activated carbon, carbon nanotubes, carbon fibres and mixtures thereof. Alternatively, the electronically-conductive constituent may be provided by a metallic material.

In general, where the component is an electrode for a battery cell and the ceramic material is an electrode active material, the particles of the electrode active material are present in the first part in an amount of at least 50 vol % relative to the volume of the first part. In general, it is preferable for the first part to contain high amounts of electrode active material, so as to increase the capacity of the battery cell. Therefore, in certain cases, the particles of the electrode active material are present in the first part in an amount of at least 60 vol % relative to the volume of the first part. In certain cases, the particles of the electrode active material are present in the first part in an amount of at least 70 vol % relative to the volume of the first part. In certain cases, the particles of the electrode active material are present in the first part in an amount of at least 80 vol % relative to the volume of the first part. Thus, for example, the particles of the electrode active material may be present in the first part in an amount of 50-80 vol % relative to the volume of the first part.

For the avoidance of doubt, the volume percentages of the materials of the first part are quoted for those portions of the first part not having the second part embedded therein.

In general, the component is thicker than the sheet. Typically, the thickness of the component is at least 30% greater than the thickness of the sheet. In certain cases, the thickness of the component is at least 50% greater than the thickness of the sheet. In still further cases, the thickness of the component is at least 80% greater than the thickness of the sheet. For the avoidance of doubt, the thickness of the component is measured in the same direction as the thickness of the sheet.

In a second aspect, the present invention may provide a method of making a component according to the first aspect of the invention, comprising the steps of:
providing a sheet having a plurality of through-thickness apertures;
combining particles of a ceramic material with a liquid phase to form a slurry; depositing the slurry onto the sheet having the plurality of through-thickness apertures;
after deposition of the slurry onto the sheet, wetting the particles of the ceramic material with a solvent that is configured to partially solubilise the ceramic material; and
sintering the wetted particles of the ceramic material by applying pressure and heat to the particles to evaporate the solvent and densify the ceramic material, wherein the sintering temperature is no more than 200° C. above the boiling point of the solvent.

For the avoidance of doubt, pressure and heat are applied simultaneously to the wetted particles to evaporate the solvent and densify the ceramic material. Furthermore, the step of wetting the particles of the ceramic material with a solvent that is configured to partially solubilise the ceramic material may effectively correspond to a step of wetting the particles of the ceramic material with a solvent that partially solubilizes the ceramic material.

Typically, the step of wetting the particles of the ceramic material with the solvent comprises applying the solvent to the particles in the form of a vapour of the solvent or by means of a spraying process.

In general, the liquid phase comprises a polymeric binder phase and the method further comprises the step, after the step of depositing the slurry onto the sheet and before the step of wetting the particles of the ceramic material with the solvent, of heating the slurry to reduce the concentration of the polymeric binder phase in the slurry. This step typically comprises holding the slurry at a temperature in the range 180-260° C. for a time of about 20 minutes or less.

Typically, the liquid phase comprises a polymeric binder phase that is dissolved in an organic medium, such as polycarbonate. In general, the organic medium is non-aqueous.

Typically, the sintering temperature is no more than 150° C. above the boiling point of the solvent. In certain cases, sintering temperature is no more than 100° C. above the boiling point of the solvent. The boiling point of the solvent refers to the boiling point at atmospheric pressure.

Typically, the sintering temperature is no more than 300° C. In certain cases, the sintering temperature is no more than 250° C. In certain cases, the sintering temperature is no more than 225° C. In certain cases, the sintering temperature is no more than 200° C. In certain cases, the sintering temperature is no more than 175° C. In certain cases, the sintering temperature is no more than 150° C.

In general, the sintering temperature is at least 50° C. In certain cases, the sintering temperature is at least 100° C. Therefore, the sintering temperature may be in the range 50-300° C., for example, 50-250° C., 50-225° C., 50-200° C., 50-175° C., or 50-150° C. Alternatively, the sintering temperature may be in the range 100-250° C., for example, 100-225° C., 100-200° C., 100-175° C., or 100-150° C. For the avoidance of doubt, the sintering temperature is the maximum temperature reached during the sintering step.

Typically, the applied pressure is 300 MPa or less. In certain cases, the applied pressure is 200 MPa or less. In certain cases, the applied pressure is 150 MPa or less. In certain cases, the applied pressure is 100 MPa or less. In certain cases, the applied pressure is 50 MPa or less.

In general, the applied pressure is at least 10 MPa. In certain cases, the applied pressure is at least 20 MPa. Thus, the applied pressure may be in the range 10-300 MPa, for example, 10-200 MPa, 10-150 MPa, 10-100 MPa, or 10-50 MPa. Alternatively, the applied pressure may be in the range 20-300 MPa, for example, 20-200 MPa, 20-150 MPa, 20-100 MPa, or 20-50 MPa.

Typically, the step of sintering the particles of the ceramic material by applying pressure and heat to the particles to evaporate the solvent and densify the ceramic material takes no longer than 60 minutes. In certain cases, this step takes no longer than 30 minutes. In certain cases, this step takes no longer than 20 minutes.

In general, this step takes at least 5 minutes. Therefore, the time required for this step may be in the range 5-60 minutes, for example, 5-30 minutes or 5-20 minutes.

Typically, the slurry is deposited onto the sheet having the plurality of through-thickness apertures through a mask.

In certain cases, the slurry is deposited onto the sheet having the plurality of through-thickness apertures by means of a sheet-to-sheet process. A sheet-to-sheet process is typically an intermittent process, and may comprise processes such as tape-casting or screen-printing process. In other cases, the deposition process may be a roll-to-roll process.

A roll-to-roll process is typically a continuous process, and may comprise processes such as comma bar, K-bar, doctor blade, slot die, flexographic, gravure, intaglio and lithographic coating methods. Detailed descriptions and requirements for these processes are given in “The Printing Ink Manual” R. H. Leach and R. J. Pierce eds. 5th ed 1993 (ISBN 0 9448905 81 6), which is hereby incorporated by reference.

In certain cases, the sheet having the plurality of through-thickness apertures is a sheet of electronically-conductive material.

In certain cases, the solvent may be an aqueous solvent. In certain cases, the solvent may be an organic solvent. In general, the solvent is selected from the group consisting of: water, acetic acid, polycarbonate, dimethylformamide and benzyl alcohol.

In certain cases, the component is an electrode for a battery cell and the ceramic material is an electrode active material. In such cases, the slurry may further comprise particles of an ion-conductive material, such as LAGP (Li_{1.5}Al_{0.5}Ge_{1.5}(PO₄)₃); LATP (Li_{1.3}Al_{0.3}Ti_{1.7}(PO₄)₃); NASICON (Na₁₊ₓZr₂SiₓP₃₋ₓO₁₂, wherein 0<x<3); LISICON (Li₂₊₂ₓZn₁₋ₓGeO₄, wherein 0<x<1); Ohara Lithium Ion Conducting Glass Ceramic (LICGC™); lithium-stuffed garnets, including compounds having the formula Li_{A}La_{B}M_{C}Zr_{D}O_{E}, wherein 4<A<8.5, 1.5<B<4, 0≤C≤2, 0≤D<2, 10<E<13 and M=Al, Mo, W, Nb, Sb, Ca, Ba, Sr, Ce, Hf, Rb, or Ta; and mixtures thereof. In general, the ion-conductive material may be a lithium-containing material, a sodium-containing material, or a magnesium-containing material. Typically, the ion-conductive material is a lithium-containing material.

In certain cases (particularly where the component is an electrode for a battery cell and the ceramic material is an electrode active material), the slurry may also comprise one or more electrolytic salts, for example, one or more salts selected from the group consisting of: LiTFSI (lithium bis(trifluoromethanesulfonyl)imide); LiFSI (lithium bis(fluorosulfonyl)imide), lithium perchlorate, and mixtures thereof. Alternatively, the one or more electrolytic salts may be dissolved in the solvent that is used to wet the particles of the ceramic material.

In certain cases (particularly where the component is an electrode for a battery cell and the ceramic material is an electrode active material), the slurry may also comprise a solid electronically-conductive constituent. However, in the case that the sheet onto which the slurry is deposited is a sheet of electronically-conductive material, it is thought that the amount of the solid electronically-conductive constituent in the slurry may be reduced. For example, the amount of the solid electronically-conductive constituent may be less than 10 vol % relative to total volume of the particles of the ceramic material (which may be an electrode active material). Preferably, the amount of the solid electronically-conductive constituent may be less than 5 vol % relative to the total volume of the particles of the ceramic material (which may be an electrode active material). Preferably, the amount of the solid electronically-conductive constituent may be less than 2 vol % relative to the total volume of the particles of the ceramic material (which may be an electrode active material). Preferably, the amount of the solid electronically-conductive constituent may be less than 1 vol % relative to the total volume of the particles of the ceramic material (which may be an electrode active material).

The sheet onto which the slurry is deposited may have one or more of the features of the second part of the component according to the first aspect of the invention.

The particles of ceramic material may have one or more of the features of the particles of ceramic material present in the electrode according to the first aspect of the invention. For the avoidance of doubt, other materials, for example, particles of a further ceramic material, may also be present in the slurry.

Typically, the particles of the ceramic material have a d50 size in the range 2-50 μm, measured using laser diffraction of a liquid dispersion of the particles, following ISO 13320:2020. For example, the particles of the ceramic material may have a d50 size in the range 2-40 μm. In certain cases, the particles of the ceramic material may have a d50 size in the range 5-40 μm. In certain cases, the particles of the ceramic material may have a d50 size in the range 5-20 μm.

In a third aspect, the present invention may provide a method of making a component according to the first aspect of the invention, comprising the steps of:
providing a sheet having a plurality of through-thickness apertures;
combining particles of a ceramic material with a solvent to form a slurry, the solvent being configured to solubilise the ceramic material;
depositing the slurry onto the sheet having the plurality of through-thickness apertures;
sintering the particles of the ceramic material by applying pressure and heat to the slurry to evaporate the solvent and densify the ceramic material, wherein the sintering temperature is no more than 200° C. above the boiling point of the solvent.

For the avoidance of doubt, pressure and heat are applied simultaneously to the mixture of particles of the ceramic material and solvent that is present in the slurry.

Typically, the slurry further comprises a polymeric binder and the method further comprises the step, after the step of sintering the slurry to densify the ceramic material, of heating the densified material to a temperature above the sintering temperature, to reduce the concentration of the polymeric binder phase in the densified material. This step typically comprises holding the densified material at a temperature in the range 180-260° C. for a time of about 20 minutes or less.

The method according to the third aspect of the invention may have the advantage, relative to the method according to the second aspect of the invention, that only one solvent is required, whereas the method according to the second aspect requires a liquid phase and a solvent to be provided in distinct steps. However, it is thought that the optional step of applying heat to reduce the concentration of any polymeric binder phase present may require more care if this step is carried out after densification of the ceramic material.

The method according to the third aspect of the invention may include one or more of the optional features of the method according to the second aspect of the invention, relating for example, to sintering temperature, applied pressure, sintering time, the method of depositing the slurry onto the sheet, and the amounts and types of materials used.

In a fourth aspect, the present invention may provide a method of making a component according to the first aspect of the invention, comprising the steps of:
providing a sheet having a plurality of through-thickness apertures;
combining particles of a ceramic material with a solvent to form a slurry, such that the solvent partially solubilizes the ceramic material;
depositing the slurry onto the sheet having the plurality of through-thickness apertures;
sintering the particles of the ceramic material by simultaneously applying pressure and heat to the slurry to evaporate the solvent and densify the ceramic material, wherein the sintering temperature is no more than 200° C. above the boiling point of the solvent.

For the avoidance of doubt, pressure and heat are applied simultaneously to the mixture of particles of the ceramic material and solvent that is present in the slurry.

Typically, the slurry further comprises a polymeric binder and the method further comprises the step, after the step of sintering the slurry to densify the ceramic material, of heating the densified material to a temperature above the sintering temperature, to reduce the concentration of the polymeric binder phase in the densified material. This step typically comprises holding the densified material at a temperature in the range 180-260° C. for a time of about 20 minutes or less.

The method according to the fourth aspect of the invention may include one or more of the optional features of the method according to the second aspect of the invention, relating for example, to sintering temperature, applied pressure, sintering time, the method of depositing the slurry onto the sheet, and the amounts and types of materials used.

In a fifth aspect, the present invention may provide a component for use in in an energy storage device or an energy conversion device, the component being obtained or obtainable through the method according to the second, third, or fourth aspects of the invention.

The component may be an electrode for a battery cell.

In a sixth aspect the present invention may provide an energy storage device or energy conversion device comprising a component according to the first or fifth aspects of the invention. The device may be selected from the group consisting of: batteries, capacitors, fuel cells (including solid oxide fuel cells and polymer electrolyte fuel cells), photovoltaic devices, piezoelectric devices, and thermoelectric converters.

In certain cases, the device may be a battery cell comprising an electrode provided by the component according to the first or fifth aspects of the invention, and an electrolyte layer disposed on a face of the electrode.

Typically, the electrolyte layer is disposed on the face of the electrode that is distal from the second part.

### DETAILED DESCRIPTION

The invention will now be described by way of example with reference to the following Figures in which:

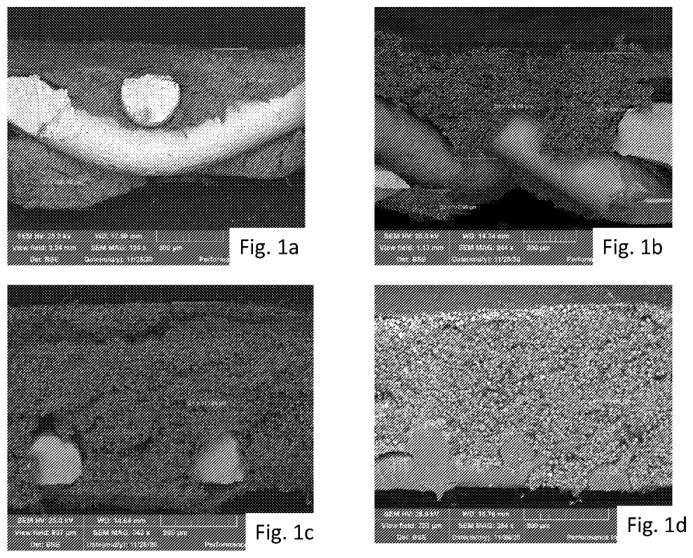

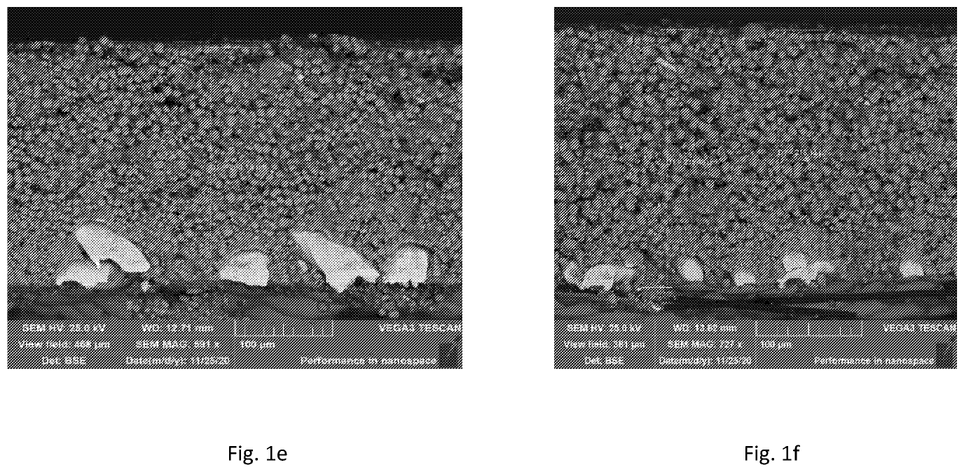

FIGS. 1a-f show scanning electron micrographs of cross sectional views of Examples 1, 2, 3, 8, 4, and 5 respectively;

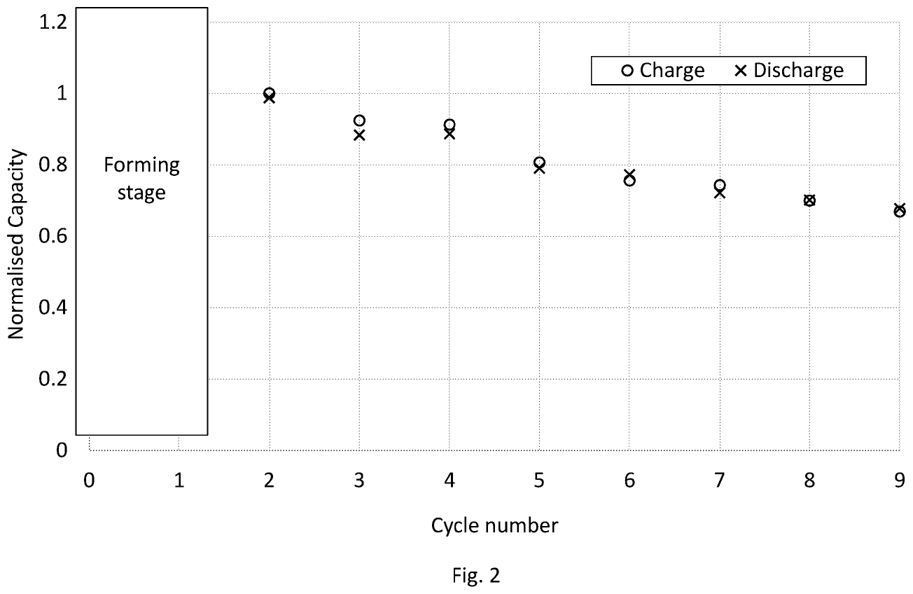

FIG. 2 is a graph of normalised capacity against cycle number for a battery cell including the cathode of Example 3;

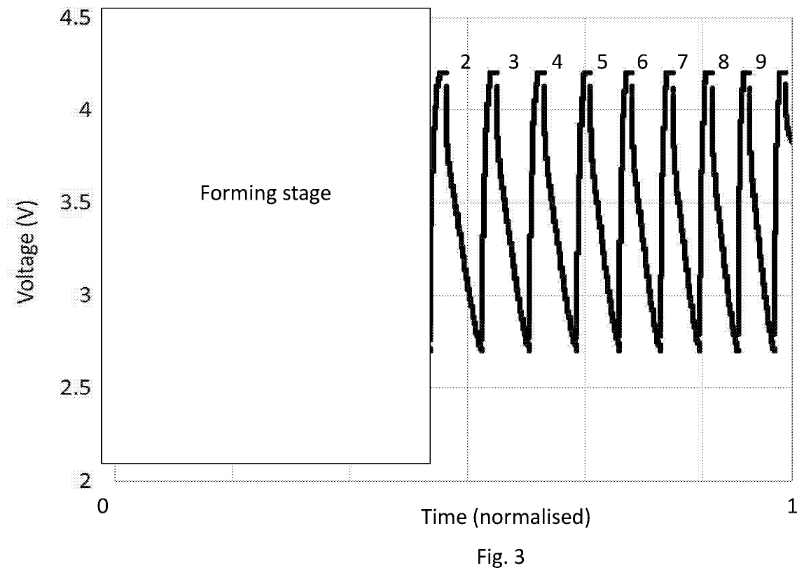

FIG. 3 is a graph of voltage against time for a battery cell including the cathode of Example 3;

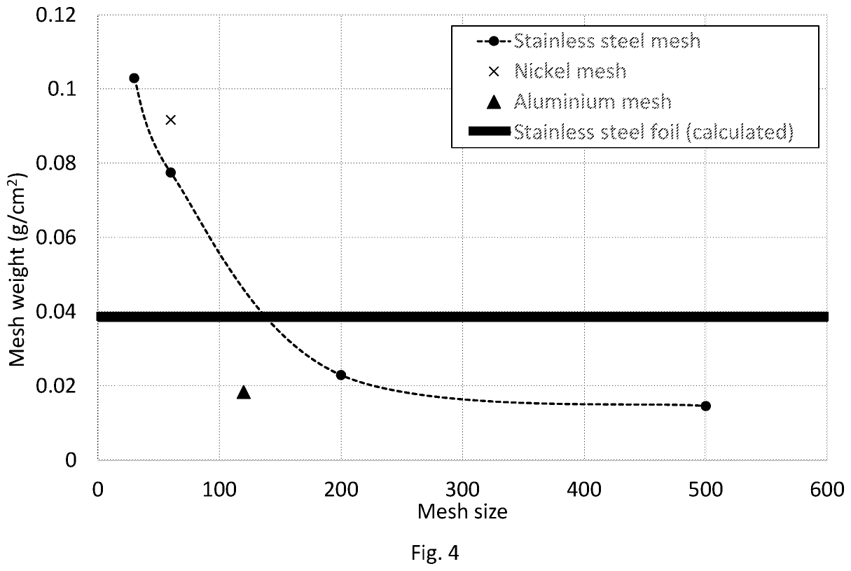

FIG. 4 is a graph of mesh weight per unit area against mesh size.

### Cathode Preparation

Slurries were prepared from the constituents set out in Table 1. First, the binder and the electrolytic salt were dissolved in the solvent and then the solvent was mixed with the remaining constituents. The mixing process was carried out in a planetary ball mixer, initially for 10 minutes at 1000 rpm, followed by 5 minutes at 800 rpm.

TABLE 1

| | | Amount |
|---|---|---|
| Constituent | Function | (wt %) |
| NMC (LiNi_{0.33}Mn_{0.33}Co_{0.33}O₂): | Particles of cathode | 38 |
| grade A or grade B | active material | |
| LAGP (Li_{1.5}Al_{0.5}Ge_{1.5}(PO₄)₃) | Particles of ionically- | 8 |
| | conductive material | |
| LITFSI | Electrolytic salt | 3 |
| Carbon nanotubes | Electronically- | 1 |
| | conductive material | |
| Propylene carbonate | Solvent for the binder | 47.5 |
| | phase and electrolytic salt | |
| Poly(propylene carbonate) | Binder phase | 2.5 |

Two NMC grades were used, and their properties are set out in Table 2. The particle size analysis was carried out using laser diffraction of a liquid dispersion of the particles, following ISO 13320:2020.

TABLE 2

| | Particle size (μm) | | |
|---|---|---|---|
| Grade | D10 | D50 | D90 |
| A | 7.2 | 12.4 | 22.1 |
| B | 6.8 | 12.7 | 23.9 |

Examples 1-12 were prepared by screen-printing the slurry onto a woven metal mesh through a mask having a thickness of 500 μm and an opening of 30-35 mm diameter. Comparative Examples 1-4 were prepared by screen-printing the slurry onto a metal foil through a mask having a thickness of 500 μm and an opening of 30-35 mm diameter.

Next, the mask was removed and the samples were heated to 250° C. at a rate of 0.5° C./minute and held at this temperature for 6 minutes to remove the organic binder phase.

Next, water was sprayed onto the surface of the screen-printed samples, in order to wet the particles of the electrode active material and partially solubilise them.

The samples were then placed in a heated uniaxial press and held at 130° C. for 10 minutes at a pressure of 30.59 MPa to sinter them.

Once the sintering step was complete, the samples were removed from the press and examined to assess the quality of the adhesion of the sintered material to the mesh or foil substrate. The quality of the adhesion was defined according to the following categories:
Poor adhesion: the sintered material did not adhere to the substrate at all;
Fair adhesion: the sintered material initially adhered to the substrate, but easily became detached, for example, when an attempt was made to cut the sample through its thickness;
Good adhesion: the sintered material adhered to the substrate, even when an attempt was made to cut the sample.

TABLE 3

| | Mesh | | Aperture | Mesh | NMC | |
|---|---|---|---|---|---|---|
| Example | size | Strands/cm | size (μm) | material | grade | Performance |
| 1 | 18 | 7.1 | 960 | Stainless | A | Good adhesion |
| | | | | steel | | |
| 2 | 30 | 11.8 | 570 | Stainless | A | Good adhesion |
| | | | | steel | | |
| 3 | 60 | 23.6 | 260 | Stainless | A | Good adhesion |
| | | | | steel | | |
| 4 | 200 | 78.7 | 70 | Stainless | A | Fair adhesion |
| | | | | steel | | |
| 5 | 500 | 196.9 | 26 | Stainless | A | Fair adhesion |
| | | | | steel | | |
| 6 | 60 | 23.6 | 250 | Nickel | A | Good adhesion |
| 7 | 60 | 23.6 | 260 | Copper | A | Good adhesion |
| 8 | 120 | 47.2 | 120 | Aluminium | B | Good adhesion |
| 9 | 30 | 11.8 | 570 | Stainless | B | Good adhesion |
| | | | | steel | | |
| 10 | 60 | 23.6 | 260 | Stainless | B | Good adhesion |
| | | | | steel | | |
| 11 | 200 | 78.7 | 70 | Stainless | B | Good adhesion |
| | | | | steel | | |
| 12 | 500 | 196.9 | 26 | Stainless | B | Good adhesion |
| | | | | steel | | |

TABLE 4

| Comparative | Substrate | Thick- | Surface | NMC | Perfor- |
|---|---|---|---|---|---|
| Example | material | ness | treatment | grade | mance |
| 1 | Stainless | 50 μm | Roughened | A | Poor |
| | steel foil | | using | | adhesion |
| | | | sandpaper | | |
| 2 | Stainless | 100 μm | Roughened | A | Poor |
| | steel foil | | using | | adhesion |
| | | | sandpaper | | |
| 3 | Aluminium | | | | No |
| | foil | | | | adhesion |

Cross sectional views of Examples 1, 2, 3, 8, 4, and 5 are shown in FIGS. 1a-f respectively.

Battery cell A battery cell was prepared using the electrode of Example 3, an LAGP/polymer electrolyte, a lithium anode and a copper current collector. After forming the battery, electrochemical testing was performed using the following procedure:
Charge=constant current to a voltage of 4.2 V, followed by maintaining the battery at this voltage for 60 minutes
Discharge=constant current to a voltage of 2.7 V.

The results are shown in FIGS. 2 and 3, which shows that cycling was successfully achieved, with high efficiency after forming stage.

### Mesh Weight

FIG. 4 is a graph of mesh weight per unit area against mesh size for stainless steel, aluminium and nickel meshes, and additionally includes a band showing the weight per unit area of typical 50 μm thick stainless steel foils. From this, is can be seen that fine meshes (e.g. aluminium mesh having a mesh size of 120, as well as stainless steel meshes having mesh sizes of 200 and 500) have a lower weight per unit area than 50 μm thick stainless steel foils. This may assist in increasing the energy density per unit weight of a battery containing an electrode according to the present invention.

1. A component for use in an energy storage device or an energy conversion device, the component comprising a first part and a second part, wherein the first part comprises particles of a ceramic material, and the second part is provided by a sheet having a plurality of through-thickness apertures;
wherein the second part is at least partially embedded in the first part.

2. The component according to claim 1, wherein the ceramic material is selected from the group consisting of: electrode active materials; electrolytes; piezoelectric materials; photovoltaic materials; and thermoelectric materials.

3. The component according to claim 1, wherein the second part is provided by a sheet of electronically conductive material.

4. The component according to claim 3, wherein the second part comprises a metal or a metal alloy.

5. The component according to claim 4, wherein the metal or metal alloy comprises one or more elements selected from the group consisting of: iron, nickel, copper, aluminium, titanium, and platinum.

6. The component according to claim 1, wherein the through-thickness apertures are arranged in a grid.

7. The component according to claim 6, wherein the second part is provided by a woven mesh.

8. The component according to claim 7, wherein the woven mesh has 5-500 strands per cm, when measured in a direction perpendicular to the strands.

9. The component according to claim 8, wherein the woven mesh has 30-250 strands per cm, when measured in a direction perpendicular to the strands.

10. The component according to claim 9, wherein the woven mesh has 30-100 strands per cm, when measured in a direction perpendicular to the strands.

11. The component according to any claim 1, wherein the apertures have a width in the range 10-1000 μm.

12. The component according to claim 11, wherein the apertures have a width in the range 10-200 μm.

13. The component according to claim 12, wherein the apertures have a width in the range 50-200 μm.

14. The component according to claim 1, wherein the component is an electrode for a battery cell, particularly a solid state battery cell, and the ceramic material is an electrode active material.

15. The component according to claim 14, wherein the particles of electrode active material comprise at least one electrode active material selected from the group consisting of: lithium nickel cobalt aluminium oxide (LiNixCoyAlzO2, wherein x>0; y>0; z>0 and x+y+z=1); lithium cobalt oxide (LiCoO2); lithium iron phosphate (LiFePO4); lithium manganese nickel oxide (LiMn1.5Ni0.5O4); lithium cobalt phosphate (LiCoPO4); lithium nickel cobalt manganese oxide (LiNixCoyMnzO2, wherein x>0; y>0; z>0 and x+y+z=1); vanadium oxide (V2O5); LiVOPO4; Li3V2(PO4)3; LiMPO4 (wherein M=Ni, Mn); tin oxide and lithium titanate oxide (Li4Ti5O12 or Li2TiO3).

16. The component according to claim 14, wherein the first part further comprises an ionically-conductive constituent that is distributed between the particles of electrode active material.

17. The component according to claim 14, wherein the amount of any electronically-conductive constituent in the first part of the electrode is less than 10 vol % relative to the total volume of the electrode active material.

18. A method of making the component according to claim 1, comprising the steps of:
providing a sheet having a plurality of through-thickness apertures;
combining particles of a ceramic material with a liquid phase to form a slurry;
depositing the slurry onto the sheet having the plurality of through-thickness apertures;
after deposition of the slurry onto the sheet, wetting the particles of the ceramic material with a solvent that is configured to partially solubilise the ceramic material; and
sintering the wetted particles of the ceramic material by applying pressure and heat to the particles to evaporate the solvent and densify the ceramic material, wherein the sintering temperature is no more than 200° C. above the boiling point of the solvent.

19. The method according to claim 18, wherein the step of wetting the particles of the ceramic material with a solvent comprises applying the solvent to the particles by means of a spraying process.

20. The method according to claim 18, wherein the step of wetting the particles of the ceramic material with a solvent comprises applying the solvent to the particles in the form of a vapour of the solvent.

21. The method according to claim 18, wherein the liquid phase comprises a polymeric binder phase and the method further comprises the step, after the step of depositing the slurry onto the sheet and before the step of wetting the particles of the ceramic material with the solvent, of heating the slurry to reduce the concentration of the polymeric binder phase in the slurry.

22. A method of making the component according to claim 1, comprising the steps of:
providing a sheet having a plurality of through-thickness apertures;
combining particles of a ceramic material with a solvent to form a slurry, the solvent being configured to solubilise the ceramic material;
depositing the slurry onto the sheet having the plurality of through-thickness apertures;
sintering the particles of the ceramic material by applying pressure and heat to the slurry to evaporate the solvent and densify the ceramic material, wherein the sintering temperature is no more than 200° C. above the boiling point of the solvent.

23. The method according to claim 22, wherein the slurry further comprises a polymeric binder and the method further comprises the step, after the step of sintering the slurry to densify the ceramic material, of heating the densified material to a temperature above the sintering temperature, to reduce the concentration of the polymeric binder phase in the densified material.

24. The method according to claim 18, wherein the sintering temperature is 300° C. or less.

25. The method according to claim 18, wherein the applied pressure is 300 MPa or less.

26. The method according to claim 18, wherein the step of sintering the particles of the ceramic material by applying pressure and heat to evaporate the solvent and densify the ceramic material takes 60 minutes or less.

27. The method according to any claim 18, wherein the particles of the ceramic material have a d50 size in the range 10 nm to 50 μm.

28. The method according to claim 18, wherein the slurry is deposited onto the sheet having the plurality of through-thickness apertures through a mask.

29. The method according to claim 18, wherein the slurry is deposited onto the sheet having the plurality of through-thickness apertures by means of a tape-casting or screen-printing process.

30. The method according to claim 18, wherein the solvent is selected from the group consisting of: water, acetic acid, polycarbonate, dimethylformamide and benzyl alcohol.

31. The method according to claim 18, wherein the component is an electrode for a battery cell, particularly a solid state battery cell, and the ceramic material is an electrode active material.

32. The method according to claim 31, wherein the slurry further comprises particles of an ion-conductive material.

33. The method according to claim 31, wherein the amount of any solid electronically-conductive constituent in the slurry is less than 10 vol % relative to the total volume of the particles of electrode active material.

34. A component for use in an energy storage device or an energy conversion device, the component being obtained or obtainable through the method according to claim 18.

35. An energy storage device or energy conversion device comprising a component according to claim 1.

36. The energy storage device or energy conversion device according to claim 35, wherein the device is selected from the group consisting of: batteries (including solid state batteries), capacitors, fuel cells (including solid oxide fuel cells and polymer electrolyte fuel cells), photovoltaic devices, piezoelectric devices, and thermoelectric converters.

37. A solid state battery cell comprising a component according to claim 1, wherein the component is an electrode, the battery cell further comprising an electrolyte layer disposed on a face of the electrode.
